(19) United States
(12) Patent Application Publication
(10) Pub. No.: US 2013/0275685 A1
(43) Pub. Date: Oct. 17, 2013

(54) INTELLIGENT DATA PRE-CACHING IN A RELATIONAL DATABASE MANAGEMENT SYSTEM

(71) Applicants: Pedro M. Barbas, Dunboyne (IE); Hana Curtis, Brooklin (CA); Ken Maycock, Lucan (IE); Pablo Perez Rodriguez, Dublin (IE)

(72) Inventors: Pedro M. Barbas, Dunboyne (IE); Hana Curtis, Brooklin (CA); Ken Maycock, Lucan (IE); Pablo Perez Rodriguez, Dublin (IE)

(73) Assignee: INTERNATIONAL BUSINESS MACHINES CORPORATION, Armonk, NY (US)

(21) Appl. No.: 13/447,569

(22) Filed: Apr. 16, 2012

(51) Int. Cl. G06F 12/08

(52) U.S. Cl. 711/137; 711/E12.017

(57) ABSTRACT

Methods and apparatus, including computer program products, implementing and using techniques for pre-caching information in a database management system. Usage patterns of the database are analyzed to identify regularly recurring requests for information stored in the database. Based on the analyzed usage patterns, a pre-caching strategy is determined. The pre-caching strategy identifies information in the database that is likely to satisfy an anticipated future request. Prior to a time at which the future request is anticipated to be received, a cache in the database is populated with information that satisfies the anticipated future request in accordance with the determined pre-caching strategy. The information that populates the cache is retrieved from a storage medium that is slower to access than the cache.

### BACKGROUND

The present invention relates to Relational Database Management Systems (RDBMSs), and more specifically, to caching of data in such systems. Databases come in many flavors. One popular form is a relational database management system (RDBMS), such as DB2™ system, which is manufactured by International Business Machines Corporation of Armonk, N.Y.

The RDBMS is responsible for handling all requests for access to the database where the data itself is actually stored, thereby shielding the users from the details of any specific hardware implementation. The performance of the RDBMS is tightly integrated to where the data is stored. For example, retrieving data from a physical disk is significantly slower than direct retrieval from machine cache. In today's computing environment the fastest hard drives (even the newer Solid State Drive (SSD) devices) have latencies of just around the order of milliseconds (typically about 0.1 ms to about 10 ms), while memory latency is in the order of nanoseconds (typically about 1 ns to 50 ns), i.e. memory is typically between 10,000 and 1,000,000 times faster. Thus, if it were possible to intelligently select where to store data, significant time savings could be achieved.

### SUMMARY

According to one embodiment of the present invention, methods and apparatus, including computer program products, are provided, which implement and use techniques for pre-caching information in a database management system. Usage patterns of the database are analyzed to identify regularly recurring requests for information stored in the database. Based on the analyzed usage patterns, a pre-caching strategy is determined. The pre-caching strategy identifies information in the database that is likely to satisfy an anticipated future request. Prior to a time at which the future request is anticipated to be received, a cache in the database is populated with information that satisfies the anticipated future request in accordance with the determined pre-caching strategy. The information that populates the cache is retrieved from a storage medium that is slower to access than the cache.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a simple representation of the learned data usage patterns for three tables, in accordance with one embodiment.

FIG. 2 shows a simple representation of pre-caching the relevant data from the “Orders for Dispatch Table” of FIG. 1 shortly prior to predicted usage, in accordance with one embodiment.

FIG. 3 shows a schematic view of an intelligent Pre-Caching system in accordance with one embodiment.

FIG. 4 shows a process for building and using a pre-caching strategy, in accordance with one embodiment.

Like reference symbols in the various drawings indicate like elements.

### DETAILED DESCRIPTION

### Overview

The various embodiments of the invention described herein provide mechanisms and algorithms allowing a RDBMS to learn what data is likely to be accessed in the near future and pre-cache that data. By populating a cache before a user/application makes a data request in the system, the user can obtain a significantly faster response from the RDBMS, even when accessing the data for the first time. The various embodiments of the pre-caching strategy are built by recognizing at least one data usage pattern by a user over a time period. In one embodiment, the RDBMS profiles repetitive user data patterns that occur during specific time periods on a regular (e.g., daily, weekly, etc.) basis. Based on the repetitive user data patterns, the pre-caching intelligent mechanism identifies information that is likely to satisfy a user request at a given time. Prior to that time, the cache is populated with the expected information. Thus, if the user makes a request as anticipated, the information will be already in the cache and will not have to be retrieved from slower storage mechanisms, e.g. a hard disk. Some embodiments also include the capability to repair an incorrect data pre-caching strategy. That is, the system monitors a previously executed pre-caching strategy, evaluates its efficiency and computes adjustments to correct and improve the model. The various embodiments of the invention can be implemented in various RDBMSs, such as, for example, the well-known DB2 database software system distributed by International Business Machines Corporation of Armonk, N.Y.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### Data Usage Patterns and Pre-Caching

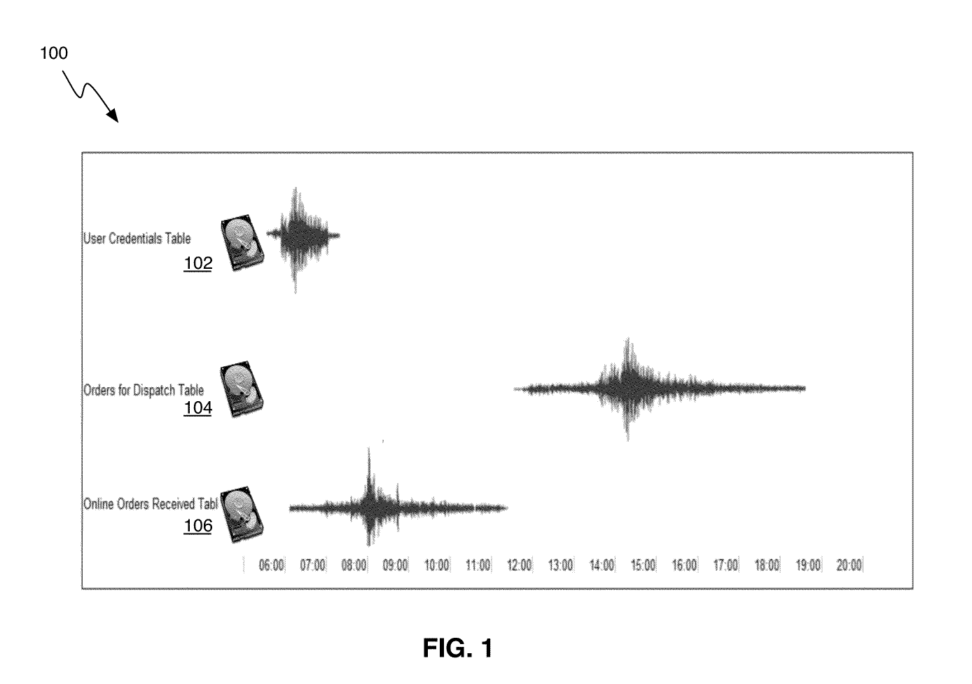

FIG. 1 shows a simple representation (100) of the learned data usage patterns for three tables, in accordance with one embodiment. As can be seen in FIG. 1, there are three tables: a “User Credentials Table” (102), an “Orders for Dispatch Table” (104) and an “Online Orders Received Table” (106).

The horizontal axis in FIG. 1 represents hours of the day. However, as the skilled person realizes, data may very well be cyclical in many other ways, such as end of month financial reports, end of day trading around certain commodities, certain shift working patterns, etc. As can be seen in FIG. 1, the usage pattern is depicted in a “Richter scale style” fashion, with the height of the respective oscillations representing the volume of data usage on the different tables. The hard disk icons represent the locations where the data is stored immediately prior to being retrieved. As can be seen in FIG. 1, all data is retrieved from hard disks. By studying and leveraging this learned data usage pattern, the data that is highly likely to be retrieved can be pre-cached, thus resulting in increased performance. Disk input/output (I/O) can be dramatically reduced at query time by accessing the queried data directly from cache.

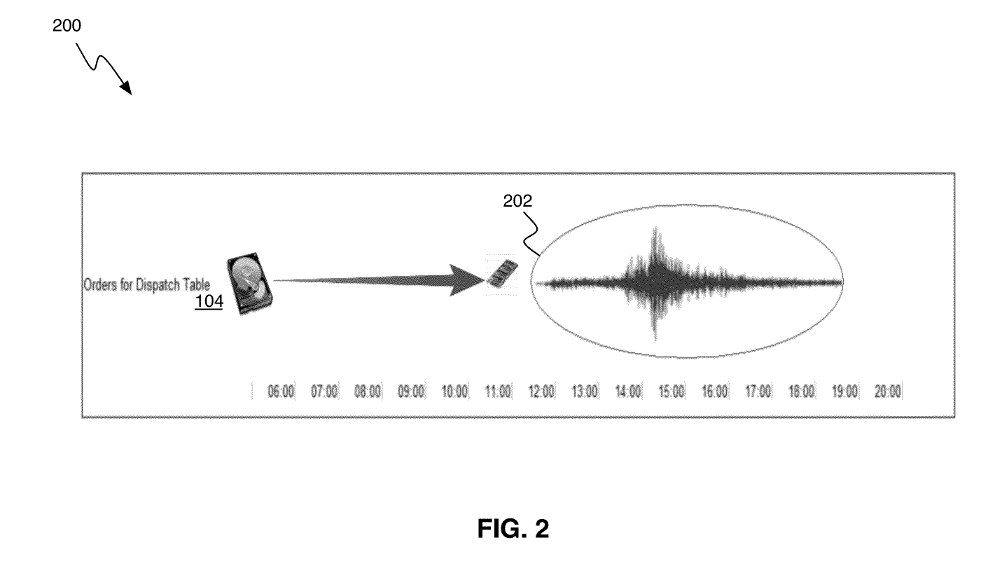

FIG. 2 shows a schematic representation of the pre-caching of the “Orders for Dispatch Table” (104) in accordance with one embodiment of the invention. The ellipse (202) represents the usage profile that has been learned concerning the “Orders for Dispatch Table” (104). That is, the “Orders for Dispatch Table” starts being leveraged from 12:00 until shortly after 18:00. Having this information, the Intelligent Data Pre-Caching Engine will pre-cache the data for this table from hard disk prior to its intended usage, therefore dramatically improving the RDBMS performance.

### Exemplary Pre-Caching System

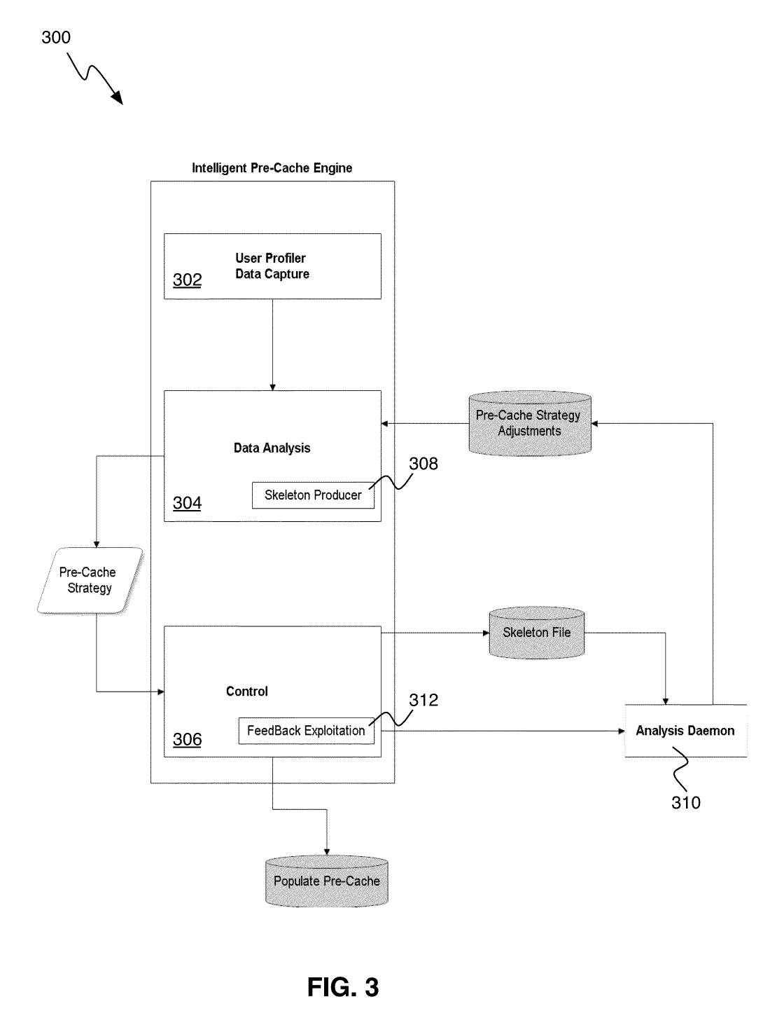

FIG. 3 shows a schematic view of an intelligent Pre-Caching system (300) in accordance with one embodiment. As can be seen in FIG. 3, the Pre-Caching system (300) includes a user profiler data capture component (302), a data analysis component (304), and a control component (306). The data capture component (302) gathers information about a user's data usage. This information is supplied to the data analysis component (304) to identify data usage patterns by the user, and calculate when entries should be pre-fetched and stored in the cache. Thus, the data analysis component (304) generates a pre-caching strategy with a recommended pre-fetching time (i.e., when given data should be pre-fetched). Based on the information generated by the data analysis component (304), the control component (306) manages the pre-fetching and caching of user information, and communicates back to the data analysis component (304) through a feedback loop.

A number of adaptive conditions are detected on a regular user's data usage pattern to enable the feedback loop. For any user, the data analysis component (304) includes a Skeleton Producer (308) that stores essential information about the chosen pre-caching strategy into a skeleton file that is later used by the control component (306). Similarly, the control component (306) includes an Analysis Daemon (310) to compute adjustments to the pre-caching strategy. A Feedback Exploitation component (312) of the control component (306) closes the feedback loop by using the adjustments to modify the pre-caching strategy skeleton file.

These components work together to exploit empirical measurements (from actual executions of a pre-caching strategy) to validate a model used by the data analysis component (304), deduce what part of the model needs correction, and then compute adjustments to the model. Moreover, these components can operate independently, but form a sequence that constitutes a continuous learning mechanism by incrementally capturing user's data usage patterns, monitoring the execution of a pre-caching strategy, analyzing the control component (306) information, and then computing adjustments to the model for future user requests.

The information collected by the user profiler data capture component (302) is supplied to the data analysis component (304). The data analysis component (304) uses the information to identify a user's data usage patterns. These patterns typically include some daily peak accesses, which are time periods during a day where the user makes the same data request. For example, the user may request the same data in the morning between 8:00 am and 9:00 am, and then again in the afternoon between 1:00 pm and 2:00 pm. Each of these periods reflects a daily peak access time. The user's daily access pattern may also identify other general data requests that are performed daily. Typically, the times at which the requests are performed over a given day are uniformly distributed within the work hours, although as the skilled person realizes, many other types of distributions of requests are also possible.

It should be noted that the user profiler data capture component (302), the data analysis component (304), the control component (306), the skeleton producer (308), the feedback exploitation component (312) and the analysis daemon (310), and various subsets thereof, can be components of the RDBMS itself, or be stand-alone components that run separately from the RDBMS.

Of course, those skilled in the art will recognize modifications that may be made to this configuration without departing from the scope of the present invention. For example, those skilled in the art will recognize that any combination of the above components, or any number of different components, including computer programs, peripherals, and other devices, may be used to implement the present invention, so long as similar functions are performed thereby. Those skilled in the art will also recognize that the components of the present invention could be tightly integrated or loosely coupled.

### Exemplary Pre-Caching Process

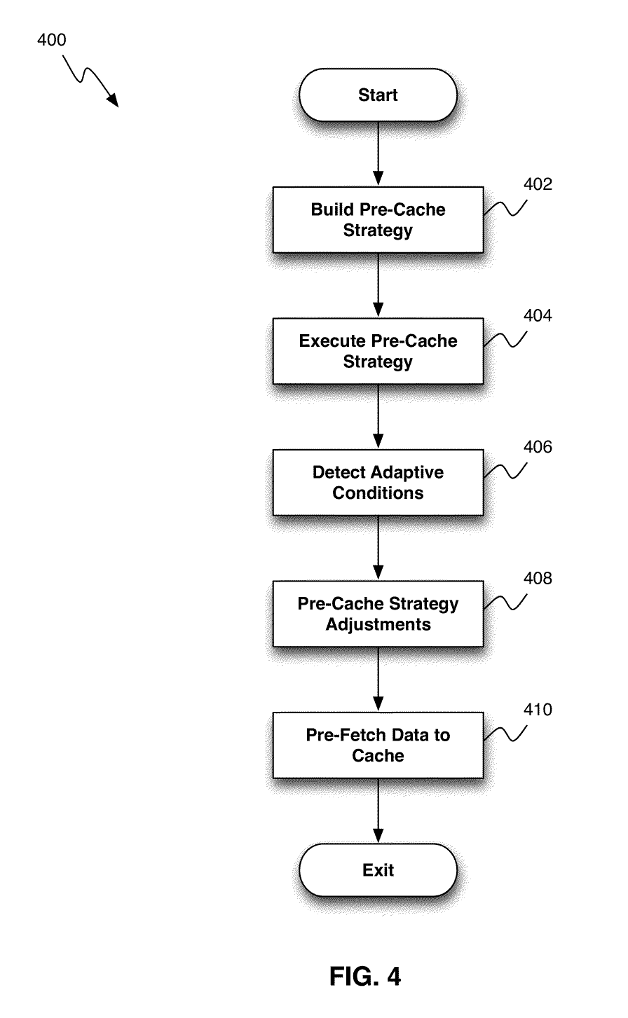

FIG. 4 shows a process (400) for building and using a pre-caching strategy, in accordance with one embodiment. The pre-caching strategy can be implemented, for example, by the intelligent pre-caching system (300), which was discussed above with reference to FIG. 3. The pre-caching strategy can be stored in any suitable format such as human readable extended markup language (XML) files, or in a proprietary binary format, for example. As can be seen in FIG. 4, the process (400) starts by building a pre-cache strategy (step 402). The pre-cache strategy can be set up for a specific user. In some embodiments, if a user has multiple instances, a pre-caching strategy can be set up for each of the instances, since the user may use different connections for distinctly different purposes. In some embodiments, the pre-caching strategy can be set up for a particular type of user, as opposed to a specific individual user. Such user types can reflect, for example, typical usage patterns for general types of users, or even more abstractly a specific type of user for an empirically recognized usage pattern. A user can be assigned to a user type explicitly, implicitly or empirically. In some embodiments, a user can be assigned to more than one user type. Each user type exhibits specific types and data usage patterns.

A pre-cache strategy can involve any data types, for example, the user's current connection, the current time of a transaction or the time of the next transaction the user needs to execute, general data consultation (such as weather forecasts or current traffic), and so forth. For a given data type, there can be one or more tables involved, views, cubes, etc., which can include any other type of data source.

Next, the pre-cache strategy is executed (step 404). As the pre-cache strategy is executed, adaptive conditions are detected (step 406), as each data event can provide for one or more adaptive conditions. Adaptive conditions represent conditions under which pre-cached data is refreshed from the data source. For example a user may retrieve traffic information when located on a specific highway; as such, a specific event may be related to the change of data usage pattern if the user changes the highway location were he or she is located. Further, adaptive conditions can include any events associated with the passage of time. For example, a specific scheduled task (e.g., make a transaction every month on the 1st day at 12:00 pm). Adaptive conditions can also include any security events. For example, the user may give authorization to other users on a specific set of data. In some embodiments, the adaptive conditions can reflect compound conditions, including multiple events or conditions of different types. For example, stock information might be refreshed every minute, but only during business hours.

Based on the detected adaptive conditions, the pre-cache strategy can optionally be adjusted accordingly (step 408), if it is detected that there is a need to do so. Finally, the data is pre-fetched to cache in accordance with the pre-cache strategy (step 410), which ends the process (400).

It should be noted that the pre-caching strategy as discussed with respect to the above process (400) is exemplary, and is not intended to be limiting. The pre-caching strategy can include other elements not discussed above, and/or could be represented in different formats. The pre-caching strategy can also be defined entirely on usage. For example, data retrieved by the user can be analyzed over a period of time, for example, a day, a week or a month. Another example can be by using database statistics to analyze data. Data types and their corresponding sources can be identified. More complex analysis can be conducted, and various patterns of data usage can be identified. Patterns can reflect any data correlations. The pre-caching strategy model can employ one or more algorithms for pattern identification. The algorithms can include collaborative filtering and other techniques often found in data mining applications such as various machine learning algorithms, as is familiar to those of ordinary skill in the art.

### Usage Scenarios and Further Variations

As was described above, the various embodiments of the pre-caching techniques can be based on several dimensions that can be found on any RDBMS system, such as data (including database statistics), space, time and history. It leverages the multidimensional, relational nature of the available RDBMS data, to predict user data usage patterns that otherwise could be overlooked.

As an illustrative example of this, consider the following usage scenario, in which three tables, Weather, Location and Route, are present in the RDBMS. Table Weather shows information for a specific weather forecast consultation. Table Route shows information about specific routes, for example, highway US1 starts on Kent, Houlton, Bangor, Portland . . . Miami and finishes on Key West. Table Location shows information for a specific city related to table Route and table Weather. User Bob is a salesperson and uses the RDBMS of his company to submit weather forecast queries while moving along specific routes during his work time. Bob is not aware of tables Location and Route, but he uses table Weather almost daily. Now let's consider the following scenario:

On Day 1, user Bob submits this query to the RDBMS: “Select details from Weather where city=‘Houlton’.” Since this is the first query submitted to the database system, the pre-cache strategy reflects this same information for this user (for example, pre-cache table Weather every day at 10:00 am).

On Day 2, user Bob submits this query to the RDBMS: “Select details from Weather where city=‘Bangor’.” At this point the pre-cache strategy detects a new adaptive condition and based on this new adaptive condition, the pre-cache algorithm is updated the following way: due to the nature of relational data it can be seen on table Route that Bangor is the second city along the US1 highway route after Houlton, and that user Bob submits his weather forecast queries on a daily basis at approximately the same time. Based on this realization, the pre-cache strategy for user Bob will be updated to reflect this new query: “Select details from Weather where city=‘Portland’.”

On Day 3, when user Bob submits this query to the RDBMS: “Select details from Weather where city=‘Portland’.”, this query has already been pre-cached by the system and the results returned to Bob are almost immediate. Conventional systems do not allow for this type of “predictive behavior”.

In this context, it is worth mentioning that the queries and algorithms used by the pre-caching system can of course also be far more complex. For example, if user Bob were submitting sales queries, he would not disclose his location in the query itself. However, since he submits the same queries “on the move” using a database mobile device for the same, then the IP location for Day 1, IP location for Day 2, etc., can be used to obtain the city were Bob was located and the data can be related this way. This is only a simple example of how the multidimensional, relational nature of the data available on the RDBMS system can be leveraged to predict incoming queries and pre-cache them for obtaining quicker responses.

As was also described above, incorrect pre-caching strategies can be repaired at any point in time based on adaptive conditions, which could involve compound conditions or multiple events (several data dimensions, space/location, time, history). To further illustrate the concept of adaptive conditions and relative usage patterns, some additional examples will now be presented.

Assume that user Bob, who belongs to a user group “Salespeople” normally access the tables Sales and Items every Monday and Thursday at 10 a.m., and that a pre-cache strategy has been constructed based on these facts. A new vendor Sally joins the same company as Bob, and the database administrator adds Sally to the database system as a member of the “Salespeople” user group, using the same security configuration. Although Sally has never made any requests to the database, the pre-cache strategy assigned to Sally will be the same as Bob, as they are both part of the “Salespeople” user group. This is a simple example of a relative usage pattern using roles.

In various embodiments, this concept can be expanded even further. For example, there may be time dependent adaptive conditions. One example of a time dependent adaptive condition relates to sales figures analysis. Typically within many sales organizations, the previous week's or quarter's sales figures will be interrogated to determine if targets are progressing as expected. With adaptive conditions, this can be detected, and sales figures for the preceding week or quarter can be pre-cached automatically on a given day when it is known that they are typically accessed. Other examples of time dependent adaptive conditions can include pre-caching stock prices and movements for the previous day's trade for a stock trader every morning, that is, the present day.

In various embodiments, there may be location dependent adaptive conditions, for example, a user moving along a highway, and submitting weather forecast queries at different points in time, hours, days, or weeks. In various embodiments there may be dimension dependent adaptive conditions. Of course, there may also be many combinations of the examples above. For example, a user requesting promotional offers, and determining to what degree weather conditions influence sales per region. Security (at every level) can also be part on the pre-cache strategy. For example, a user may be allowed to see rows in a sales table only where “city=Dublin”. Another example can be a user requesting traffic conditions, at different locations and at different hours.

All these examples can be considered adaptive conditions, and they can be used to enhance a pre-cache strategy that is working less than optimally, as shown in the above examples. Further, as was described above, the various embodiments of the data pre-caching system can work at higher levels of abstraction, where the strategy may, for example, exploit assigned user roles rather than individual users (e.g., the data needs for a manager often differ from the data needs for a data analyst, or for an executive) or be based on a combination of factors or circumstances (thanks to the multidimensional nature of the data in an RDBMS system).

Some embodiments described herein can take leverage from database query optimizers in database systems. Database query optimizers typically rely on statistics (for example, the number of rows in a table, the number of distinct values in a column, the most frequently-occurring values in a column, the distribution of data values in a column, etc.) that characterize the data in order to choose appropriate query execution plans to retrieve data needed to answer queries. These statistics may be determined from an inspection of the tables of the database, or from a set of stored statistical values. As such, the various pre-caching strategies described above may leverage from those statistics where one or more algorithms for pattern identification can be used. For example if the most frequently-occurring values in column city in the table “Weather” are Miami and Portland, then when the pre-caching strategy is being constructed for user Bob the cities Miami and Portland are considered if they need to be part of the pre-caching strategy for this user.

In some embodiments, the cache can be used as a “store-in” cache. Thus, the version of the data in the cache can be more recent than the version of the data that is stored on disk. For example, when a force-at-commit is applied, the updated data is written to the cache, and the version of the data that resides on the disk is now down-level.

Some embodiments may implement artificial intelligence (AI) algorithms, such as, for example, the Hierarchical Linear Modeling (HLM) algorithm and multiple regression models in a way that allows the resulting variables to be changed and verified at several hierarchical levels. Such models and various variations thereof are well known to those of ordinary skill in the art.

### Concluding Comments

It is important to note that the term “user” in the above examples does not solely refer to human users, but rather to a database consumer, which may be human or non-human, such as computer systems, applications, bots, other databases, etc., or various combinations thereof, as is clearly understood by those of ordinary skill in the art.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer-implemented method for pre-caching information in a database management system, the method comprising:
analyzing usage patterns of the database to identify regularly recurring requests for information stored in the database;
based on the analyzed usage patterns, determining a pre-caching strategy, the pre-caching strategy identifying information in the database that is likely to satisfy an anticipated future request; and
prior to a time at which the future request is anticipated to be received, populating a cache in the database with information that satisfies the anticipated future request in accordance with the determined pre-caching strategy, the information populating the cache being retrieved from a storage medium that is slower to access than the cache.

2. The method of claim 1, wherein the pre-caching strategy includes one or more of:
a connection for a current user, a current time of a request, a time at which an anticipated subsequent request is expected to occur for a user, and a general data consultation.

3. The method of claim 1, further comprising:
modifying the pre-caching strategy based on one or more adaptive conditions, the adaptive conditions including one or more of: time-based adaptive conditions, location-based adaptive conditions, and security-based adaptive conditions.

4. The method of claim 1, wherein the database management system is a relational database management system.

5. The method of claim 1, wherein analyzing usage patterns of the database includes one or more of: analyzing usage patterns based on individual users, and analyzing usage patterns based on groups of users sharing a common user profile.

6. The method of claim 1, wherein populating the cache occurs shortly before the time at which the anticipated future request is expected to be received.

7. The method of claim 1, further comprising storing the pre-caching strategy in one of: an extended markup language file format and a proprietary binary format.

8. The method of claim 1, wherein determining a pre-caching strategy includes predicting a future request that is different from a received historical requests for a particular user or user group, based on the analyzed usage pattern for the particular user or user group.

9. The method of claim 1, further comprising using the pre-caching strategy to take leverage from a query optimizer for the database management system.

10. A computer program product for pre-caching information in a database management system, the computer program product comprising:
a computer readable storage medium having computer readable program code embodied therewith, the computer readable program code comprising:
computer readable program code configured to analyze usage patterns of the database to identify regularly recurring requests for information stored in the database;
computer readable program code configured to, based on the analyzed usage patterns, determine a pre-caching strategy, the pre-caching strategy identifying information in the database that is likely to satisfy an anticipated future request; and
computer readable program code configured to, prior to a time at which the future request is anticipated to be received, populate a cache in the database with information that satisfies the anticipated future request in accordance with the determined pre-caching strategy, the information populating the cache being retrieved from a storage medium that is slower to access than the cache.

11. The computer program product of claim 10, wherein the pre-caching strategy includes one or more of: a connection for a current user, a current time of a request, a time at which an anticipated subsequent request is expected to occur for a user, and a general data consultation.

12. The computer program product of claim 10, further comprising:
computer readable program code configured to modify the pre-caching strategy based on one or more adaptive conditions, the adaptive conditions including one or more of: time-based adaptive conditions, location-based adaptive conditions, and security-based adaptive conditions.

13. The computer program product of claim 10, wherein the database management system is a relational database management system.

14. The computer program product of claim 10, wherein the computer readable program code configured to analyze usage patterns of the database includes one or more of: computer readable program code configured to analyze usage patterns based on individual users, and computer readable program code configured to analyze usage patterns based on groups of users sharing a common user profile.

15. The computer program product of claim 10, wherein populating the cache occurs shortly before the time at which the anticipated future request is expected to be received.

16. The computer program product of claim 10, further comprising computer readable program code configured to store the pre-caching strategy in one of: an extended markup language file format and a proprietary binary format.

17. The computer program product of claim 10, wherein the computer readable program code configured to determine a pre-caching strategy includes computer readable program code configured to predict a future request that is different from a received historical requests for a particular user or user group, based on the analyzed usage pattern for the particular user or user group.

18. The computer program product of claim 10, further comprising computer readable program code configured to use the pre-caching strategy to take leverage from a query optimizer for the database management system.

19. A system for pre-caching information in a database management system, comprising:
a processor;
a memory storing instructions operable to be executed by the processor, wherein the instructions include instructions causing a pre-cache engine to perform the following operations:
analyzing usage patterns of the database to identify regularly recurring requests for information stored in the database;
based on the analyzed usage patterns, determining a pre-caching strategy, the pre-caching strategy identifying information in the database that is likely to satisfy an anticipated future request; and
prior to a time at which the future request is anticipated to be received, populating a cache in the database with information that satisfies the anticipated future request in accordance with the determined pre-caching strategy, the information populating the cache being retrieved from a storage medium that is slower to access than the cache.

20. The system of claim 19, wherein the pre-caching strategy includes one or more of:
a connection for a current user, a current time of a request, a time at which an anticipated subsequent request is expected to occur for a user, and a general data consultation.

21. The system of claim 19, further comprising instructions causing the pre-cache engine to perform the following operation:
modifying the pre-caching strategy based on one or more adaptive conditions, the adaptive conditions including one or more of: time-based adaptive conditions, location-based adaptive conditions, and security-based adaptive conditions.

22. The system of claim 19, wherein the database management system is a relational database management system.

23. The system of claim 19, wherein analyzing usage patterns of the database includes one or more of: analyzing usage patterns based on individual users, and analyzing usage patterns based on groups of users sharing a common user profile.

24. The system of claim 19, wherein determining a pre-caching strategy includes predicting a future request that is different from a received historical requests for a particular user or user group, based on the analyzed usage pattern for the particular user or user group.

25. The system of claim 19, further comprising using the pre-caching strategy to take leverage from a query optimizer for the database management system.
